(19) United States
(12) Patent Application Publication
(10) Pub. No.: US 2016/0364692 A1
(43) Pub. Date: Dec. 15, 2016

(54) METHOD FOR AUTOMATIC ASSESSMENT OF A CANDIDATE AND A VIRTUAL INTERVIEWING SYSTEM THEREFOR

(71) Applicant: Wipro Limited, Bangalore (IN)

(72) Inventors: Sindhu BHASKARAN, Bangalore (IN); Anasuya Devi KOMPELLA, Bangalore (IN)

(21) Appl. No.: 14/814,893

(22) Filed: Jul. 31, 2015

(30) Foreign Application Priority Data
Jun. 12, 2015 (IN) 2941/CHE/2015

(51) Int. Cl. G06Q 10/10

(52) U.S. Cl. CPC G06Q 10/1053

(57) ABSTRACT

The present disclosure relates to a method and a virtual interviewing system for automatic assessment of a candidate. In one embodiment, the virtual interviewing system receives profile information associated with one or more candidates and job description details associated with the job. The profile information is processed to identify candidates having skills or expertise areas matching with the job description. The virtual interviewing system conducts interview to the candidates whose profiles are matching with the job description. A set of questions are provided to the candidates and the corresponding answers are evaluated based on predetermined answers stored in a knowledge base. An overall score is determined for each candidate and performance of the candidates is captured in an assessment report. Based on the assessment reports, one or more candidates are selected as qualifying candidates, thus reducing the human intervention in recruiting candidates for an enterprise or organization.

### PRIORITY CLAIM

This U.S. patent application claims priority under 35 U.S.C. §119 to India Application No. 2941/CHE/2015, filed Jun. 12, 2015. The entire contents of the aforementioned application are incorporated herein by reference.

### FIELD OF THE DISCLOSURE

The present subject matter is related, in general to assessment system, and more particularly, but not exclusively to method and a virtual interviewing system for automatic assessment of a candidate.

### BACKGROUND

Generally, as organizations grow leaner, there is an increased focus on reduction in manual processes and automation to increase productivity. Recruitment is one major time consuming processes in any organization. Finding the right talent on an ongoing basis is a major pre-requisite for retaining competitive advantage. Organizations have a significant amount of workforce dedicated to mining the job sites, finding the right profiles, screening them through interviewing panels, short-listing them and selecting them. Conventional methods of screening and shortlisting the candidates face challenges in finding a right interviewing panelists with required skills and experience as well as in identifying the availability of the interviewing panelists matching with the candidate's availability.

Further, the conventional methods also experience difficulty in sustaining the consistency, and quality of assessment from one panel to another panel which varies based on factors like the number of candidates, number of panels and availability of candidates for the assessment process. The impact of these challenges is multi-fold that includes increased manual efforts thus increasing the recruitment overhead, increasing percentage of bad hires, increased hiring cost and decreased quality of overall deliverables in the organization.

Therefore, there is a need for method and system for reducing reliance on manual recruitment of the candidates for a particular job profile.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of automatic assessment of a candidate by a virtual interviewing system. The method comprising the steps of receiving profile information associated with one or more candidates and job description details associated with job. Further, the method comprises a step of identifying a plurality of expertise areas of the one or more candidates from the received profile information matching with the job description details and providing a plurality of questions to the candidate corresponding to the identified plurality of expertise areas. Upon evaluating the response of the one or more candidates to the plurality of questions based on one or more model answers stored in a knowledge repository, a score for the plurality of questions is determined. Based on the score obtained, the one or more candidates are ranked and candidates having maximum score are selected as qualifying candidates.

Further, the present disclosure relates to a virtual interviewing system for automatic assessment of a candidate. The system comprises a processor and a knowledge repository coupled with the processor and configured to store at least a plurality of questions and job description details associated with the job provided by the recruiter. The system further comprises a memory communicatively coupled to the processor, wherein the memory stores processor-executable instructions, which, on execution, cause the processor to receive profile information associated with one or more candidates and job description details associated with job. The processor is furthermore configured to identify a plurality of expertise areas of the one or more candidates from the received profile information matching with the job description details. The processor is also configured to provide a plurality of questions to the candidate selected from the plurality of matching expertise areas. The processor is further configured to determine a score for the plurality of questions in real time upon evaluating the response of the one or more candidates based on one or more model answers stored in a knowledge repository of the virtual interviewing system. Based on the score obtained, the processor ranks the one or more candidates and select candidates having maximum score as qualifying candidates.

Furthermore, the present disclosure relates to a non-transitory computer readable medium including instructions stored thereon that when processed by at least one processor cause a system to perform the act of receiving profile information associated with one or more candidates and job description details associated with job. Further, the instructions cause the processor to identify a plurality of expertise areas of the one or more candidates from the received profile information matching with the job description details. The processor is also configured to provide a plurality of questions to the candidate selected from the plurality of matching expertise areas. Furthermore, the instructions cause the processor to. Still further, the instructions cause the processor to determine a score for the plurality of questions in real time upon evaluating the response of the one or more candidates based on one or more model answers stored in a knowledge repository of the virtual interviewing system. Based on the score obtained, the processor ranks the one or more candidates and select candidates having maximum score as qualifying candidates.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an architecture diagram of an exemplary system for automatic assessment of a candidate in accordance with some embodiments of the present disclosure;

FIG. 2 illustrates an exemplary block diagram of a virtual interviewing system of FIG. 1 in accordance with some embodiments of the present disclosure;

FIG. 3 illustrates a flowchart of an exemplary method of automatic assessment of a candidate in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a virtual interviewing system for automatic assessment of a candidate. In one embodiment, the virtual interviewing system receives profile information associated with one or more candidates and job description details associated with the job. The profile information is processed to identify candidates having skills or expertise areas matching with the job description. The virtual interviewing system conducts interview to the candidates whose profiles are matching with the job description. A set of questions are provided to the candidates and the corresponding answers are evaluated based on predetermined answers stored in a knowledge base. An overall score is determined for each candidate and performance of the candidates is captured in an assessment report. Based on the assessment reports, one or more candidates are selected as qualifying candidates, thus reducing the human intervention in recruiting candidates for an enterprise or organization.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

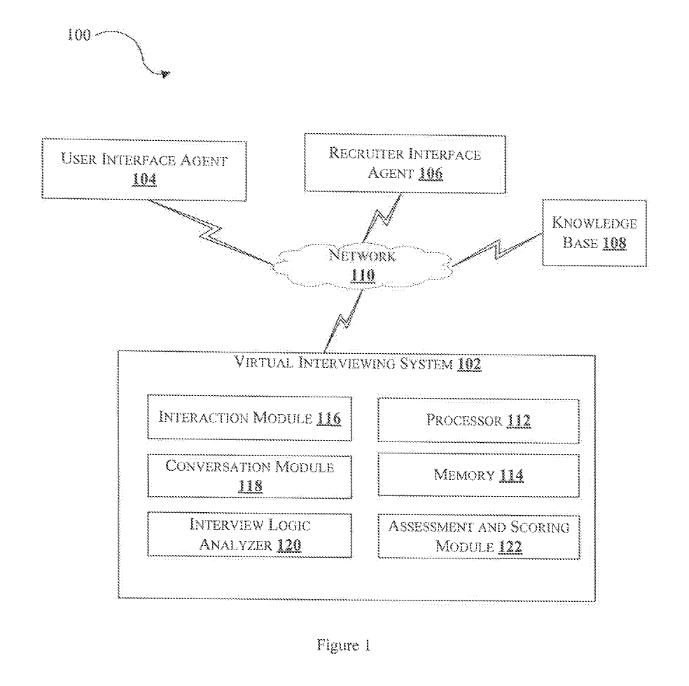

FIG. 1 illustrates an architecture diagram of an exemplary system for automatic assessment of a candidate in accordance with some embodiments of the present disclosure.

As shown in FIG. 1, the exemplary system 100 comprises one or more components configured for automatic assessment of a plurality of candidates. In one embodiment, the exemplary system 100 comprises a virtual interviewing system 102 (hereinafter referred to as VIS 102), a user interface agent (hereinafter referred to as UIA) 104, a recruiter interface agent (hereinafter referred to as RIA) 106 and a knowledge repository (interchangeably referred to as knowledge base) 108 connected via a communication network 110. The VIS 102 enables automatic assessment of the plurality of candidates by interacting through the UIA 104 based on information stored in the knowledge base 108. In one embodiment, the UIA 104, the RIA 106 and the knowledge base 108 may be integrated within the VIS 102. In another embodiment, the UIA 104, the RIA 106 and the knowledge base 108 may be implemented independent of VIS 102.

The RIA 106 is configured to present a recruiter interface to a recruiting organization or a company or an enterprise to input job description details. For example, the job description details include one or more skills or expertise areas required to meet the job requirements and weightage criteria associated with the one or more skills or expertise areas. In one embodiment, the RIA 106 enables the recruiter to create job description details by choosing one or more skills or expertise areas from a predefined list of skills and by selecting a competency level to each of the chosen skills or expertise areas. The RIA 106 also enables the recruiter to assign weightage to each of the chosen skills or expertise areas and to further assign weightage to one or more sub-areas of each skill or expertise area. For example, a skill or expertise area like Core Java can be divided into the one or more sub-areas like socket programming with 20% weightage, multi-threading with 20% weightage and IO streaming with 10% weightage and so on. In addition, the RIA 106 also enables the recruiter to define one or more optional skills or expertise areas that can be used as tie-breaker if a significant number of candidates are found equally suitable for the job description.

The RIA 106 is further configured to enable the recruiter interface to receive input candidate profile information including candidate details and/or candidate profiles. The recruiter interface enables a recruiter who may be a person seeking to fill a position using the interview based on target job requirement. The person may be a business owner, an individual, an agent acting on behalf of a business or individual or any other type of people having a requirement to fill a job vacancy. A recruiting decision may be made as a result of the interview to establish a relationship between a candidate who fills the position and the recruiter. The job position or vacancy may be associated with any of business, services, or social positions. The RIA 106 displays a list of candidates having profiles matching with the job requirements and enables each candidate in the generated list to input his/her rating on the skills or expertise areas required for the job on a predefined scale for example 1 to 10. Upon shortlisting the plurality of candidates based on profile matching and highest rating, the plurality of candidates are assessed based on the plurality of questions provided to the candidates via the UIA 104.

In one embodiment, the UIA 104 is configured to present the plurality of questions via the user interface to the plurality of candidates. The UIA 104 can be implemented on a web based or mobile or any computing device based interface for example, on a mobile or tablet or desktop based or TV or immersive screen. The UIA 104 enables a plurality of input devices or interfaces to receive and capture inputs provided by the plurality of candidates. The plurality of input devices or interfaces include for example, voice based interfaces/devices like speaker or microphone, gesture based interfaces like gloves, bands or any other types of devices, visual interfaces like camera or holographic interfaces or projectors, physiological sensing devices, and so on. In another embodiment, the plurality of input devices or interfaces includes any known sensor devices or interfaces capable of capturing user inputs. The UIA 104 is configured to provide the plurality of questions which could be voice based or text based questions via the virtual interview interface to the plurality of candidates. The UIA 104 is also configured to receive one or more responses to the plurality of questions from the plurality of candidates in voice or text format that are analyzed based on one or more predetermined model answers stored in the knowledge base 108.

The knowledge base 108 stores knowledge or ontology or data associated with the plurality of questions and one or more model answers corresponding to the plurality of questions. For example, the knowledge base 108 stores training data or information related to one or more skills or expertise areas and skill area specific ontology and dictionaries that enable the VIS 102 to process the plurality of questions and identify the relevant answers. The plurality of questions is categorized into one or more categories based on a plurality of parameters like complexity and type of questions. Complexity may be for example simple, medium and complex and the type of questions may be for example, multiple choice questions, code snippet based questions, short answer questions, open-ended questions, relationship-based questions, single word/phrase answer questions, additional probing questions, and so on.

Multiple Choice questions are objective questions which will give multiple choices to the candidates from which one or more answers can be chosen. Code snippet based or code correction based questions are meant to assess candidate's coding skills. The candidate is given a question and a program. He/she is expected to correct a given code segment as per the expectations stated in the code, compile and run the program. The knowledge base 108 also stores the one or more answers for the plurality of questions along with corresponding score. Short answer questions are questions that can be answered in free-form spoken natural language by the candidates. Open-ended questions are questions that needs a description of a concept and can be expressed in multiple ways. For example, what is polymorphism, what is multi-threading and so on. Relationship-based questions are questions that require an answer about relationships between subjects and objects. For example, what is the difference between overloading and overriding. Single word/phrase answer questions are questions that correspond to single word or single phrase answers or with finite options. Answers may also be in the form of affirmative/non-affirmative, list, or range for example, what is the return type of main method in java, Name all or any four primitive data types in java, Is main method mandatory in a java class and so on. The knowledge base 108 is configured manually or automatically with the plurality of questions and corresponding answers in all categories.

In one embodiment, the knowledge base 108 is manually configured with the plurality of questions and corresponding answers. In another embodiment, the knowledge base 108 is automatically configured with the one or more answers derived from knowledge corpus for example, tutorials, API references, Wikipedia and so on. In yet another embodiment, the knowledge base 108 is automatically configured with plurality of questions and corresponding answers received from community forums. In still another embodiment, the knowledge base 108 is automatically configured with plurality of questions and corresponding answers that are manually reviewed and validated. Based on the plurality of candidate's responses to the plurality of questions, the VIS 102 assess the one or more candidates and identify suitable candidates matching to the job description as required by the recruiter.

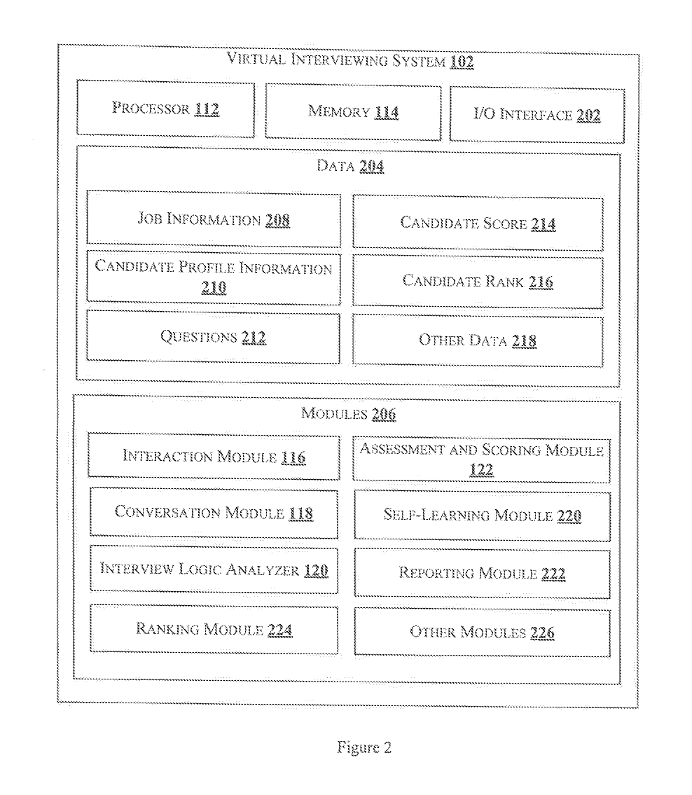

The VIS 102 may be configured as a stand-alone workstation for example, a kiosk or a networked system for example, an Internet web based system. In one embodiment, the VIS 102 comprises a central processing unit (“CPU” or “processor”) 112, a memory 114, an interaction module 116, a conversation module 118, an interview logic analyzer (ILA) 120 and an assessment and scoring module (ASM) 122. The VIS 102 may be a typical VIS as illustrated in FIG. 2. The VIS 102 comprises the processor 112, the memory 114 and an I/O interface 202. The I/O interface 202 is coupled with the processor 110 and an I/O device. The I/O device is configured to receive inputs via the I/O interface 202 and transmit outputs for displaying in the I/O device via the I/O interface 202.

The VIS 102 further comprises data 204 and modules 206. In one implementation, the data 204 and the modules 206 may be stored within the memory 114. In one example, the data 204 may include job information 208, candidate profile information 210, questions and answers 212, candidate score 214, candidate rank 216 and other data 218. In one embodiment, the data 204 may be stored in the memory 114 in the form of various data structures. Additionally, the aforementioned data can be organized using data models, such as relational or hierarchical data models. The other data 218 may be also referred to as reference repository for storing recommended implementation approaches as reference data. The other data 218 may also store data, including temporary data and temporary files, generated by the modules 206 for performing the various functions of the VIS 102.

The modules 206 may include, for example, the interaction module 116, the conversation module 118, the interview logic analyzer (ILA) 120, the assessment and scoring module (ASM) 122, a self-learning module 220, a reporting module 222 and a ranking module 224. The modules 206 may also comprise other modules 226 to perform various miscellaneous functionalities of the VIS 102. It will be appreciated that such aforementioned modules may be represented as a single module or a combination of different modules. The modules 206 may be implemented in the form of software, hardware and or firmware.

In one embodiment, the interaction module 116 is configured to enable one or more interactions between the user and recruiter with respective user and recruiter interfaces. The interaction module 116 processes one or more events associated with the user and recruiter interfaces and route the one or more processed events to appropriate module for further processing. For example, the interaction module 116 processes the one or more events associated with user and recruiter interfaces and transmit the events to UIA 104 and RIA 106 respectively. Upon receiving the respective events, the UIA 104 and RIA 106 enable the interactions between the user and the VIS 102 or between the recruiter and the VIS 102 to receive the necessary input information from the user or from the recruiter. Interactions may also include exchange of information between the user and recruiter with respective user and recruiter interfaces. In one example, interactions may also be referred to as conversation.

The conversation module 118 enables the one or more interactions between the user and the VIS 102 in natural language format during the interviewing process. In one embodiment, the conversation module 118 comprises one or more sub-modules including natural language understanding (NLU) module, a dialog interaction module and a natural language generation (NLG) module. The NLU understanding module enables the understanding of the input information provided in natural language format by the plurality of candidates through the UIA 104. The dialog interaction module enables the interpretation of the input information provided by the plurality of candidates. In one embodiment, the dialog interaction module determines the sufficiency of the input information based on context of the plurality of questions and generates one or more clarifications or suggestions or another plurality of questions upon determination. The NLG module converts the generated clarifications or suggestions or another set of questions into corresponding natural language format as output and transmits the output to the plurality of candidates via the user interface.

The ILA 120 may be a business process layer for the assessment process. The ILA 120 enables the interaction module 116 to conduct the interactions or conversation between the plurality of candidates or recruiter and the VIS 102 during the assessment. The ILA 120 also initializes the knowledge base 108 with the job requirement details 208, plurality of candidate profile information 210, the one or more skills or expertise areas. Based on the initialized information in the knowledge base 108, the ILA 120 generates an interview logic that includes the sequence of plurality of questions 212 to be made to the plurality of candidates based on the one or more skills or expertise areas of corresponding candidates. In one embodiment, the ILA 120 determines the number of questions for each skill or expertise area based on weightage criteria assigned in the job description or requirement details. The ILA 120 further determines the complexity of the plurality of questions 212 based on the competency level defined in the job description. The ILA 120 dynamically fetches the number of questions from the knowledge base 108 from the plurality of categories based on determined complexity. Based on the one or more responses to the plurality of questions 212, the ILA 120 may modify the number of questions, complexity level, sequence of questions, and category of questions and so on. One or more responses to the plurality of questions 212 from the plurality of candidates are received and a corresponding candidate score 214 is determined by the ASM 122.

In one embodiment, the ASM 122 receives the one or more responses to the plurality of questions 212 and determines corresponding scores 214 in real time. The ASM 122 receives the one or more responses to the plurality of questions 212 that were received and interpreted by the dialog interaction module for sufficiency, and determines corresponding scores 214 based on the one or more responses and the assigned weightage criteria. In one embodiment, if the category of the plurality of questions 212 is determined to be a multiple choice questions, then the ASM 122 validates the one or more responses or answers given by the plurality of candidates against one or more predefined model answers stored in the knowledge base 108 and the candidate score 214 is determined accordingly. In another embodiment, if the category of the plurality of questions 212 is determined to be a code correction based questions, then the ASM 122 compares the output of the program or code given by the plurality of candidates with one or more predefined model answers and determines a corresponding candidate score 214. In yet another embodiment, if the category of the plurality of questions 212 is determined to be short answer type questions, then the ASM 122 analyzes the one or more responses or answers given by the plurality of candidates and assigns a corresponding based on one or more answers stored in the knowledge base 108.

In still another embodiment, if the category of the plurality of questions 212 is determined to be open-ended questions, the ASM 122 evaluates the one or more responses or answers using automated short answer scoring techniques. In one example, the automated short answer scoring techniques involve natural language processing and machine learning techniques. The ASM 122 extracts one or more features like significant words using known techniques for example, Part of Speech (POS) tagging technique, Bag of words and so on and determines a corresponding score based on the extracted features. In one embodiment, the ASM 122 determines the corresponding score 214 based on the extracted features and a predetermined data model that were created from one or more training data sets during initialization of the knowledge base 108.

Further, in another embodiment, if the category of the plurality of questions 212 is determined to be relationship-based questions, the ASM 122 parses the order and dependency relation patterns of the one or more responses or answers, and evaluates the validity or semantic correctness of the parsed patterns with predefined order and dependency patterns stored in the knowledge base 108. The ASM 122 also extracts a plurality of answer themes from the one or more responses or answers and evaluates the similarity of the extracted plurality of answer themes with predefined themes and subthemes stored in the knowledge base 108 using known similarity matching techniques. Accordingly, the ASM 122 determines the corresponding candidate score 214 upon similarity evaluation. In yet another embodiment, if the category of the plurality of questions 212 is determined to be single word/phrase answer questions, the ASM 122 evaluates the one or more responses or answers of the plurality of candidates matching with previously stored domain specific synonyms and jargons stored in the knowledge base 108 and determine the corresponding candidate score 214 based on matching evaluation.

The ASM 122 also determines if further or additional probing questions are to be provided to the plurality of candidates based on factors like quality of the one or more responses or answers. In one embodiment, if it is determined that additional probing questions are required, the ASM 122 renders a plurality of follow-up questions 212 to the plurality of candidates and receives corresponding answers to the plurality of follow-up questions. For example, if the plurality of candidates has not addressed all parts of the question, then the ASM 122 determines that a follow-up question 212 is needed so that a fair chance is provided to the plurality of candidates to talk about the missing portions. In another embodiment, if it is determined that additional probing questions 212 are not required, the ASM 122 renders a plurality of advance questions on the same context or topic and receives corresponding answers to the plurality of advance questions. For example, if the weightage attached to the skills/expertise area demands additional advance questions 212, then the ASM 122 determined that advanced questions 212 should be provided to the plurality of candidates in order to assess the depth or expertise of the plurality of candidates in the skills/expertise area. Finally, the ASM 122 determines the corresponding score 214 based on the received answers.

In yet another embodiment, the ASM 122 determines that further questions must be posted to the plurality of candidates based on the performance of the plurality of candidates at a certain complexity level. Furthermore, in still another embodiment, the ASM 122 determines that the plurality of candidates' self-rating in the skill/expertise area contains the same weightage as required in the job description, then the ASM 122 provides additional questions 212 in the same expertise area to assess the plurality of candidates as per the self-rating and receives responses to the additional questions 212. Based on the received responses, the ASM 122 determines the scores. Upon determining the scores, the plurality of candidates is ranked based on the determined scores. The ranking module 224 provides a candidate rank 216 to each candidate based on the evaluation of the answers provided by the plurality of candidates and generate a score card upon ranking. In one embodiment, the score card of each candidate may comprise scores 214 in each category of questions like multiple choice questions, code correction and short answers, weighted average across all categories, scores per each skill area in the order of weightage assigned to the skill areas in job description. In another embodiment, the score card also comprises qualitative data that can help in further assessment. Qualitative data may include for example, number of times the follow up questions were asked and the corresponding skill/expertise area. This qualitative data helps the ranking module 224 to determine the existence of knowledge of a concept by the plurality of candidates. In another example, qualitative data may include the performance of plurality of candidates for advanced or additional probing questions that may help the ranking module 224 to determine the depth of understanding of a skill/expertise area. In yet another example, the qualitative data may also include the time taken to answer the plurality of questions and determination of whether the candidate's performance in required skill/expertise areas matches against the candidate's self-rating. Determination of candidate's performance enables the ranking module 224 to understand whether the candidate understands his/her strength or weakness in required skills/expertise areas. Upon generating the score card and providing ranking to the plurality of candidates, the ranking module 224 identifies one or more qualifying candidates.

In one embodiment, the ranking module 224 compares the score card of the plurality of candidates in the order of rank 216 with the number of jobs available. In one example, the plurality of candidates having high candidate scores 214 in individual skill/expertise areas as well as overall score is automatically qualified. In another example, between candidates who have same overall score 212, those who scored highest in the skill/expertise areas that carry maximum weightage are qualified. In yet another example, if there are multiple candidates who crossed required thresholds in all skill areas, then qualitative data will be used for determining the ranking based on which one or more qualifying candidates are identified.

After identifying one or more qualifying candidates, the self-learning module 220 provides the score card and ranking of the plurality of candidates to the recruiter for any review. Based on the review by the recruiter, the knowledge base 108 is updated with changes in the score card and/or ranking and updates to ontology/training data comprising plurality of questions, one or more model answers and corresponding scores. Upon updating the knowledge base 108, the VIS 102 generates assessment reports of the candidates. In one embodiment, the reporting module 222 generates one or more reports with detailed visualization in respect of the candidate's performance/ranking for all knowledge/skill/expertise areas to the enterprise/company/organization. The VIS 102 therefore enables automatic virtual interviewing or assessment of candidates without human intervention and provides an interface to the candidates through which the candidates are assessed in natural language and in a human conversational manner.

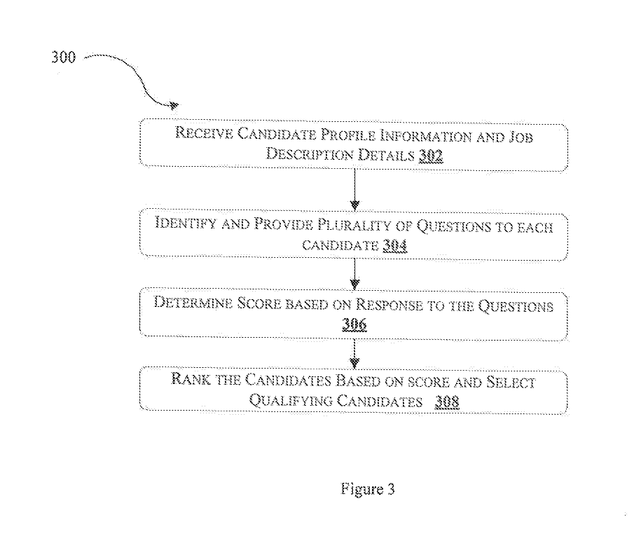

FIG. 3 illustrates a flowchart of a method of automatic assessment of a candidate in accordance with some embodiments of the present disclosure.

As illustrated in FIG. 3, the method 300 comprises one or more blocks implemented by the processor 112 for automatic assessment of a candidate. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 302, receive candidate profile information and job description details. In one embodiment, RIA 106 enables the recruiter to create job description details by choosing one or more skills or expertise areas from a predefined list of skills and by selecting a competency level to each of the chosen skills or expertise areas. The RIA 106 also enables the recruiter to assign weightage to each of the chosen skills or expertise areas and to further assign weightage to one or more sub-areas of each skill or expertise area. For example, a skill or expertise area like Core Java can be divided into the one or more sub-areas like socket programming with 20% weightage, multi-threading with 20% weightage and 10 streaming with 10% weightage and so on. In addition, the RIA 106 also enables the recruiter to define one or more optional skills or expertise areas that can be used as tie-breaker if a significant number of candidates are found equally suitable for the job description. The RIA 106 is further configured to enable the recruiter interface to receive input candidate profile information including candidate details and/or candidate profiles. The RIA 106 displays a list of candidates having profiles matching with the job requirements and enables each candidate in the generated list to input his/her rating on the skills or expertise areas required for the job on a predefined scale for example 1 to 10.

At block 304, identify and provide plurality of questions to each candidate. In one embodiment, the conversation module 118 enables the one or more interactions between the user and the VIS 102 in natural language format during the interviewing process. In one embodiment, the conversation module 118 comprises one or more sub-modules including natural language understanding (NLU) module, a dialog interaction module and a natural language generation (NLG) module. The NLU understanding module enables the understanding of the input information provided in natural language format by the plurality of candidates through the UIA 104. The dialog interaction module enables the interpretation of the input information provided by the plurality of candidates. In one embodiment, the dialog interaction module determines the sufficiency of the input information based on context of the plurality of questions and generates one or more clarifications or suggestions or another plurality of questions upon determination. The NLG module converts the generated clarifications or suggestions or another set of questions into corresponding natural language format as output and transmits the output to the plurality of candidates via the user interface.

The ILA 120 may be a business process layer for the assessment process. The ILA 120 enables the interaction module 116 to conduct the interactions or conversation between the plurality of candidates or recruiter and the VIS 102 during the assessment. The ILA 120 also initializes the knowledge base 108 with the job requirement details 208, plurality of candidate profile information 210, the one or more skills or expertise areas. Based on the initialized information in the knowledge base 108, the ILA 120 generates an interview logic that includes the sequence of plurality of questions 212 to be made to the plurality of candidates based on the one or more skills or expertise areas of corresponding candidates. In one embodiment, the ILA 120 determines the number of questions for each skill or expertise area based on weightage criteria assigned in the job description or requirement details. The ILA 120 further determines the complexity of the plurality of questions 212 based on the competency level defined in the job description. The ILA 120 dynamically fetches the number of questions from the knowledge base 108 from the plurality of categories based on determined complexity. Based on the one or more responses to the plurality of questions 212, the ILA 120 may modify the number of questions, complexity level, sequence of questions, and category of questions and so on.

At block 306, determine score based on response to the plurality of questions. In one embodiment, the ASM 122 receives the one or more responses to the plurality of questions 212 and determines corresponding scores 214 in real time. The ASM 122 receives the one or more responses to the plurality of questions 212 that were received and interpreted by the dialog interaction module for sufficiency, and determines corresponding scores 214 based on the one or more responses and the assigned weightage criteria. In one embodiment, if the category of the plurality of questions 212 is determined to be a multiple choice questions, then the ASM 122 validates the one or more responses or answers given by the plurality of candidates against one or more predefined model answers stored in the knowledge base 108 and the candidate score 214 is determined accordingly. In another embodiment, if the category of the plurality of questions 212 is determined to be a code correction based questions, then the ASM 122 compares the output of the program or code given by the plurality of candidates with one or more predefined model answers and determines a corresponding candidate score 214. In yet another embodiment, if the category of the plurality of questions 212 is determined to be short answer type questions, then the ASM 122 analyzes the one or more responses or answers given by the plurality of candidates and assigns a corresponding based on one or more answers stored in the knowledge base 108.

In still another embodiment, if the category of the plurality of questions 212 is determined to be open-ended questions, the ASM 122 evaluates the one or more responses or answers using automated short answer scoring techniques. In one example, the automated short answer scoring techniques involve natural language processing and machine learning techniques. The ASM 122 extracts one or more features like significant words using known techniques for example, Part of Speech (POS) tagging technique, Bag of words and so on and determines a corresponding score based on the extracted features. In one embodiment, the ASM 122 determines the corresponding score 214 based on the extracted features and a predetermined data model that were created from one or more training data sets during initialization of the knowledge base 108.

Further, in another embodiment, if the category of the plurality of questions 212 is determined to be relationship-based questions, the ASM 122 parses the order and dependency relation patterns of the one or more responses or answers, and evaluates the validity or semantic correctness of the parsed patterns with predefined order and dependency patterns stored in the knowledge base 108. The ASM 122 also extracts a plurality of answer themes from the one or more responses or answers and evaluates the similarity of the extracted plurality of answer themes with predefined themes and subthemes stored in the knowledge base 108 using known similarity matching techniques. Accordingly, the ASM 122 determines the corresponding candidate score 214 upon similarity evaluation. In yet another embodiment, if the category of the plurality of questions 212 is determined to be single word/phrase answer questions, the ASM 122 evaluates the one or more responses or answers of the plurality of candidates matching with previously stored domain specific synonyms and jargons stored in the knowledge base 108 and determine the corresponding candidate score 214 based on matching evaluation.

The ASM 122 also determines if further or additional probing questions are to be provided to the plurality of candidates based on factors like quality of the one or more responses or answers. In one embodiment, if it is determined that additional probing questions are required, the ASM 122 renders a plurality of follow-up questions 212 to the plurality of candidates and receives corresponding answers to the plurality of follow-up questions. For example, if the plurality of candidates has not addressed all parts of the question, then the ASM 122 determines that a follow-up question 212 is needed so that a fair chance is provided to the plurality of candidates to talk about the missing portions. In another embodiment, if it is determined that additional probing questions 212 are not required, the ASM 122 renders a plurality of advance questions on the same context or topic and receives corresponding answers to the plurality of advance questions. For example, if the weightage attached to the skills/expertise area demands additional advance questions 212, then the ASM 122 determined that advanced questions 212 should be provided to the plurality of candidates in order to assess the depth or expertise of the plurality of candidates in the skills/expertise area. Finally, the ASM 122 determines the corresponding score 214 based on the received answers.

In yet another embodiment, the ASM 122 determines that further questions must be posted to the plurality of candidates based on the performance of the plurality of candidates at a certain complexity level. Furthermore, in still another embodiment, the ASM 122 determines that the plurality of candidates' self-rating in the skill/expertise area contains the same weightage as required in the job description, then the ASM 122 provides additional questions 212 in the same expertise area to assess the plurality of candidates as per the self-rating and receives responses to the additional questions 212. Based on the received responses, the ASM 122 determines the scores. Upon determining the scores, the plurality of candidates is ranked based on the determined scores.

At block 308, rank the candidates based on score and select qualifying candidates. In one embodiment, ranking module 224 provides a candidate rank 216 to each candidate based on the evaluation of the answers provided by the plurality of candidates and generate a score card upon ranking. In one embodiment, the score card of each candidate may comprise scores 214 in each category of questions like multiple choice questions, code correction and short answers, weighted average across all categories, scores per each skill area in the order of weightage assigned to the skill areas in job description. In another embodiment, the score card also comprises qualitative data that can help in further assessment. Upon generating the score card and providing ranking to the plurality of candidates, the ranking module 224 identifies one or more qualifying candidates.

In one embodiment, the ranking module 224 compares the score card of the plurality of candidates in the order of rank 216 with the number of jobs available. In one example, the plurality of candidates having high candidate scores 214 in individual skill/expertise areas as well as overall score is automatically qualified. In another example, between candidates who have same overall score 212, those who scored highest in the skill/expertise areas that carry maximum weightage are qualified. In yet another example, if there are multiple candidates who crossed required thresholds in all skill areas, then qualitative data will be used for determining the ranking based on which one or more qualifying candidates are identified.

After identifying one or more qualifying candidates, the self-learning module 220 provides the score card and ranking of the plurality of candidates to the recruiter for any review. Based on the review by the recruiter, the knowledge base 108 is updated with changes in the score card and/or ranking and updates to ontology/training data comprising plurality of questions, one or more model answers and corresponding scores. Upon updating the knowledge base 108, the VIS 102 generates assessment reports of the candidates. In one embodiment, the reporting module 222 generates one or more reports with detailed visualization in respect of the candidate's performance/ranking for all knowledge/skill/expertise areas to the enterprise/company/organization.

The method 300 thus enables automatic virtual interviewing or assessment of candidates without human intervention and provides an interface to the candidates through which the candidates are assessed in natural language and in a human conversational manner.

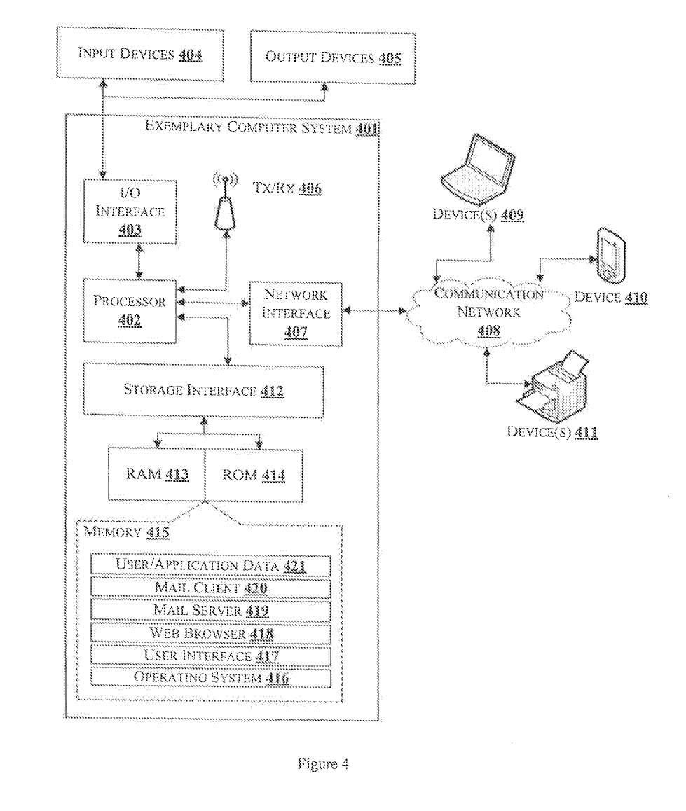

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable (Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB38, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found.14, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found.16, user interface application 4Error! Reference source not found.17, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DH)-TML, Adobe Flash, JavaScript, Java, application programming interfaces (APIs), etc. In some embodiments, the computer system 301 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 206, amongst other things, include routines, programs, objects, components, and data structures, which perform particular tasks or implement particular abstract data types. The modules 206 may also be implemented as, signal processor(s), state machine(s), logic circuitries, and/or any other device or component that manipulate signals based on operational instructions. Further, the modules 206 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of automatic assessment of a candidate by a virtual interviewing system, the method comprising:
receiving, by a processor of the virtual interviewing system, profile information associated with one or more candidates and job description details associated with job;
identifying, by the processor, a plurality of expertise areas of the one or more candidates from the received profile information matching with the job description details;
providing, by the processor, a plurality of questions to the candidate corresponding to the identified plurality of expertise areas;
determining, by the processor, a score for the plurality of questions in real time upon evaluating response of the one or more candidates based on one or more model answers stored in a knowledge repository of the virtual interviewing system; and
ranking, by the processor, the one or more candidates based on the score obtained and selecting one or more qualified candidates having maximum score.

2. The method as claimed in claim 1, further comprising:
creating a knowledge repository comprising at least the plurality of expertise areas, the plurality of questions related to each expertise area, the one or more model answers corresponding to the plurality of questions, and a corresponding score for the one or more model answers; and
storing job description details associated with the job based on expertise areas required, associated competency level and weightage score assigned to the expertise areas in the knowledge repository thus created.

3. The method as claimed in claim 1, wherein providing the plurality of questions comprising:
determining order and count of the plurality of questions based on the weightage assigned in the job description details provided by a recruiter;
determining level of complexity of questions based on the associated competency level of the job description details;
providing the plurality of questions based on the complexity level; and
dynamically modifying the complexity level of questions based on the response received from the candidate to the plurality of questions.

4. The method as claimed in claim 1, wherein the plurality of questions are selected from at least one category of multiple choice questions, code correction based questions, short answer type questions, open ended questions, relationship-based questions, and single word-phrase answer questions and so on.

5. The method as claimed in claim 1, wherein determining the score for the plurality of questions comprising:
receiving answers corresponding to the plurality of questions of at least one category; and
determining the score by comparing the received answers with the model answers previously determined and stored in the knowledge repository.

6. The method as claimed in claim 1, further comprising:
determining as to whether a follow-up question is needed based on the evaluation of the answers received from the one or more candidates;
providing the follow-up question based on the determination and receiving the answers corresponding to the follow-up question;
determining as to whether a plurality of additional probing questions is needed on the same expertise area if the candidate's answer indicates additional probing; and
rendering the plurality of additional probing questions to the candidate upon determination.

7. The method as claimed in claim 1, wherein the score is determined based on the score of the one or more candidate in each expertise area, weighted average across the plurality of expertise areas, number of follow-up questions, evaluation of answers to additional probing questions, time taken to answer the plurality of questions.

8. The method as claimed in claim 1, further comprising updating the knowledge repository based on the answers provided by the candidate to the plurality of questions and associated score.

9. A virtual interviewing system for automatic assessment of a candidate, comprising:
a processor;
a knowledge repository coupled with the processor and configured to store at least a question base and job description details associated with the job provided by the recruiter; and
a memory disposed in communication with the processor and storing processor-executable instructions, the instructions comprising instructions to:
receive profile information associated with one or more candidates and job description details associated with job;
identify a plurality of expertise areas of the one or more candidates from the received profile information matching with the job description details;
provide a plurality of questions to the candidate selected from the plurality of matching expertise areas;
determine a score for the plurality of questions in real time upon evaluating response of the one or more candidates based on one or more model answers stored in the knowledge repository of the virtual interviewing system; and
rank the one or more candidates based on the score obtained and selecting the one or more qualified candidates having maximum score.

10. The system as claimed in claim 9, wherein the processor is configured to:
create a knowledge repository comprising at least the plurality of expertise areas, the plurality of questions related to each expertise area, the one or more model answers corresponding to the plurality of questions, and a corresponding score for the one or more model answers; and
store job description details associated with the job based on expertise areas required, associated competency level and weightage score assigned to the expertise areas in the knowledge repository thus created.

11. The system as claimed in claim 9, wherein the processor is configured to provide the plurality of questions selected from at least one category of multiple choice questions, code correction based questions, short answer type questions, open ended questions, relationship-based questions, single word/phrase answer questions and so on, by performing the steps of:
determining order and count of the plurality of questions based on the weightage assigned in the job description details provided by a recruiter;
determining level of complexity of questions based on the associated competency level of the job description details;
providing the plurality of questions based on the complexity level; and
dynamically modifying the complexity level of questions based on the response received from the candidate to the plurality of questions.

12. The system as claimed in claim 9, wherein the processor is configured to determine the score for the plurality of questions by the steps of:
receiving answers corresponding to the plurality of questions of at least one category; and
determining the score by comparing the received answers with the model answers previously determined and stored in the knowledge repository.

13. The system as claimed in claim 9, wherein the processor is further configured to:
determine as to whether a follow-up question is needed based on the evaluation of the answers received from the one or more candidates;
provide the follow-up question based on the determination and receive the answers corresponding to the follow-up question;
determine as to whether a plurality of additional probing questions is needed on the same expertise area if the candidate's answer indicates additional probing; and
render the plurality of additional probing questions to the candidate upon determination.

14. The system as claimed in claim 9, wherein the processor is configured to determine the score based on the score of the one or more candidate in each expertise area, weighted average across the plurality of expertise areas, number of follow-up questions, evaluation of answers to additional probing questions, time taken to answer the plurality of questions.

15. The system as claimed in claim 9, wherein the processor is further configured to update the knowledge repository based on the answers provided by the candidate to the plurality of questions and associated score.

16. A non-transitory computer readable medium including instructions stored thereon that when processed by at least one processor cause a system to perform acts of:
receiving profile information associated with one or more candidates and job description details associated with job;
identifying a plurality of expertise areas of the one or more candidates from the received profile information matching with the job description details;
providing a plurality of questions to the candidate selected from the plurality of matching expertise areas;
determining a score for the plurality of questions in real time upon evaluating response of the one or more candidates based on one or more model answers stored in a knowledge repository of the virtual interviewing system; and
ranking the one or more candidates based on the score obtained and selecting the one or more qualified candidates having maximum score.

17. The medium as claimed in claim 16, wherein the instructions, on execution, further cause the at least one processor to:
create a knowledge repository comprising at least the plurality of expertise areas, the plurality of questions related to each expertise area, the one or more model answers corresponding to the plurality of questions, and a corresponding score for the one or more model answers; and
store job description details associated with the job based on expertise areas required, associated competency level and weightage score assigned to the expertise areas in the knowledge repository thus created.

18. The medium as claimed in claim 16, wherein the instructions, on execution, cause the at least one processor to provide the plurality of questions by the steps of:
determining order and count of the plurality of questions based on the weightage assigned in the job description details provided by a recruiter;
determining level of complexity of questions based on the associated competency level of the job description details;
providing the plurality of questions based on the complexity level; and
dynamically modifying the complexity level of questions based on the response received from the candidate to the plurality of questions.

19. The medium as claimed in claim 16, wherein determining the score for the plurality of questions, wherein the plurality of questions may be selected from at least one category of multiple choice questions, code correction based questions, short answer type questions, open ended questions, relationship-based questions, single word/phrase answer questions and so on, comprising:
receiving answers corresponding to the plurality of questions of at least one category; and
determining the score by comparing the received answers with the model answers previously determined and stored in the knowledge repository.

20. The medium as claimed in claim 16, wherein the instructions, on execution, cause the at least one processor to:
determine to whether a follow-up question is needed based on the evaluation of the answers received from the one or more candidates;
provide the follow-up question based on the determination and receiving the answers corresponding to the follow-up question;
determine as to whether a plurality of additional probing questions is needed on the same expertise area if the candidate's answer indicates additional probing;
render the plurality of additional probing questions to the candidate upon determination; and
update the knowledge repository based on the answers provided by the candidate to the plurality of questions and associated score,
wherein the score is determined based on the score of the one or more candidate in each expertise area, weighted average across the plurality of expertise areas, number of follow-up questions, evaluation of answers to additional probing questions, time taken to answer the plurality of questions.
